(19) United States
(12) Patent Application Publication
(10) Pub. No.: US 2011/0000813 A1
(43) Pub. Date: Jan. 6, 2011

(54) REUSABLE TOTE FOR HAZARDOUS CHEMICALS

(76) Inventor: Richard E. Dombkowski, Apex, NC (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 12/815,143

(22) Filed: Jun. 14, 2010

Related U.S. Application Data
(60) Provisional application No. 61/186,757, filed on Jun. 12, 2009.

(51) Int. Cl. B65D 85/84; F17C 1/02

(52) U.S. Cl. 206/524.5; 220/586

(57) ABSTRACT

Systems and methods for transporting and dispensing hazardous chemicals are described. A container is described that is resistant to the detrimental effects of the chemicals. The container comprises a first shell configured to contain a corrosive chemical, and an optional second shell surrounding the first shell and a spacer that maintains separation of the first and second shells. A valve provides access through which the corrosive chemical is discharged under pressure from the container. An interstitial space is provided between first and second shells. In some of these embodiments, the spacer seals the interstitial space. The second shell is configured to contain any of the corrosive chemical that escapes the first shell. The container may be repeatedly charged, transported, mounted on a dispensing platform from which measured amounts of the chemicals are discharged before the container is returned for clearing and recharging.

### CROSS-REFERENCE TO RELATED APPLICATIONS

The present application claims priority from U.S. Provisional Patent Application No. 61/186,757 filed Jun. 12, 2009, entitled “A Reusable Tote For Hazardous Chemicals,” which is expressly incorporated by reference herein for all purposes.

### BACKGROUND OF THE INVENTION

1. Field of the Invention

2. Description of Related Art

Transportation of hazardous chemicals creates challenges. In one example, hazardous chemicals used in agriculture, may be provided for use as fumigants by a manufacturer or distributor and may be dispensed from equipment mounted on the back of a tractor or other vehicle. Containers of the chemical are filled, transported and connected to the dispensing equipment in steps that offer opportunities for leakage of the chemicals and exposure by persons handling the containers and operating the dispensing equipment. Moreover, the chemicals are often corrosive with respect to materials used for containers and these containers are subjected to physical stresses and impacts during transportation and use.

### BRIEF SUMMARY OF THE INVENTION

Certain embodiments of the present invention comprise systems for safely transporting, storing and using hazardous chemical compounds. The systems employ a container that typically comprises at least one shell constructed from one or more layers of material and having an inner surface of plastic that is resistant to corrosion by Group 1 chemicals. The container may have an outer shell that has an inner surface that is also resistant to corrosion by Group 1 chemicals. Where plural shells are used, the inner shell and the outer shell are arranged such that the outer shell contains any leakage emanating from the inner shell.

In certain embodiments, the inner and outer shells are constructed such that the outer shell contains any leakage from the inner shell. The innermost layer of the shells are typically configured to contact chemicals stored in the container and typically have at least a surface layer formed from a polymer material resistant to corrosion by stored chemicals. In some embodiments, the container comprises at least one shell that is constructed entirely from a polymer material resistant to corrosion. Depending on the chemical to be transported, the polymer material may be a polyethylene. In one example, the chemical is a fumigant used to treat soil. Shells may include a metallic layer coated with the polymer material.

The container is typically fitted with a valve assembly. In one example, the valve assembly comprises an entrance valve coupled to a source of a compressed inert gas, an exit valve coupled to a dispensing system and a straw extending into the innermost shell. The chemical can be extracted from the inner shell through the straw under pressure of the compressed inert gas. The outer shell includes a base adapted for securing the container during transport and during application of the stored chemicals, such application including, for example, discharging the content into soil using agricultural equipment. A lift bar may be configured for safely transferring or docking the container with agricultural equipment. The container may conform to standards for transporting Packing Group I chemicals.

### BRIEF DESCRIPTION OF THE DRAWINGS

FIG. 1 is a schematic drawing of a container constructed according to certain aspects of the invention.

FIGS. 2A and 2B depict cross-sectional views of certain containers constructed according to certain aspects of the invention.

FIG. 3 shows detail of the handling mechanism and a cross-sectional view of a portion of a flange in the container of FIG. 1.

FIG. 4 is a drawing illustrating certain container wall construction according to certain aspects of the invention.

FIG. 5 shows an apparatus used for dispensing a fumigant using a container constructed according to certain aspects of the invention.

FIG. 6 is a flowchart of one process used to fill or refill a container constructed according to certain aspects of the invention.

FIG. 7 depicts a simplified, stylized valve used in connection with a container constructed according to certain aspects of the invention.

FIG. 8 is a schematic drawing of a container constructed according to certain aspects of the invention.

FIG. 9 is a schematic drawing of a container constructed according to certain aspects of the invention.

FIG. 10 is a schematic drawing of a container constructed according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise a tote that may be structured as a tank, oftentimes cylindrical in form, which may be used for transporting, storing and dispensing agricultural chemicals. The totes described herein may be constructed to withstand physical and chemical stresses allowing the totes to be used for transporting agricultural materials that include hazardous and/or corrosive chemicals. For example, a typical tote system is capable of withstanding an internal operating pressure of at least 420 pounds per square inch (“psi”) and may carry up to 1000 pounds of water content. Totes can be configured for applications in which greater internal pressure and more than 1000 pounds of water content are transported. Totes constructed according to certain aspects of the invention may be triple stacked for storage and therefore, the systems can withstand loading that can exceed at least three times the weight of each fully loaded tote. The totes and the constituent components are typically constructed to conform to regulations such as regulations promulgated by the U.S. Department of Transportation (“DOT”) and regulations set forth in agreements concerning International Carriage of Dangerous Goods by Road (ADR). For example, the totes and their constituent tanks can withstand DOT drop test requirements.

Certain embodiments of the invention may be used for transporting, storing and dispensing agricultural chemicals. In one example, the agricultural chemicals comprise Methyl Iodide (also referred to herein as “Iodomethane”) which is corrosive, and can be hazardous if mishandled. Methyl Iodide is a very active compound, having low use rate and a weight per gallon of 18.99 lbs, which combined attributes result in a relatively low volume applied per acre. Applications of some formulations are as low as 28% of the volume of other materials that could be applied using fumigation equipment. This low volume can be accurately distributed using orifice plates and/or smaller inner diameter tubing on chisel lines. The use of such tubing requires that cylinders of distribution equipment be maintained clear and clean and that the level of contaminants in the formulated product be minimized.

In certain embodiments, a container used to store and transport hazardous materials can serve as a storage tank that can be mounted on equipment used to dispense hazardous materials. In one example, the container may be used to store and transport Iodomethane and can also be used as a reservoir and/or supply of Iodomethane mounted on agricultural systems used to dispense Iodomethane. Iodomethane is a fumigant that is a colorless liquid at 20° C., and that will flow through injection equipment and/or tubing at ambient room temperature. The solubility of Iodomethane in water is 14.2 g/L, and it can be mixed with water without the use of emulsifiers. Further, Iodomethane in the presence of light turns orange-brown and rapidly photo-degrades. Its lifetime in the atmosphere is 1.5-4 days, which inhibits it from reaching the ozone layer and therefore Iodomethane is classified as a non-ozone depleting compound (the ozone depleting potential of methyl iodide is 0.0015 as reported by Ko, “Estimates of Atmospheric Lifetime, Global Warming Potential and Ozone Depletion Potential of Iodomethane (CH.sub.3I)”, Executive Summary III, Atmospheric and Environmental Research, Inc. (Report Date Oct. 31, 2000).

The corrosiveness of Iodomethane to carbon steel has been documented and in some cases Iodomethane has been corrosive to poly vinyl chloride (PVC) pipe. The volatility of Iodomethane is similar to that of methyl bromide. Iodomethane has a Henry's Law Constant of 0.22 compared to 0.24 for methyl bromide, which means that Iodomethane, like methyl bromide, will change from a liquid to a gas once it is injected into the soil. The molecular weight of iodomethane is 141.9, and it has a density of 2.28 g/ml. Iodomethane is non-flammable and non-explosive, and it currently finds uses in the fields of medicine, organic synthesis, microscopy, and testing for pyridine.

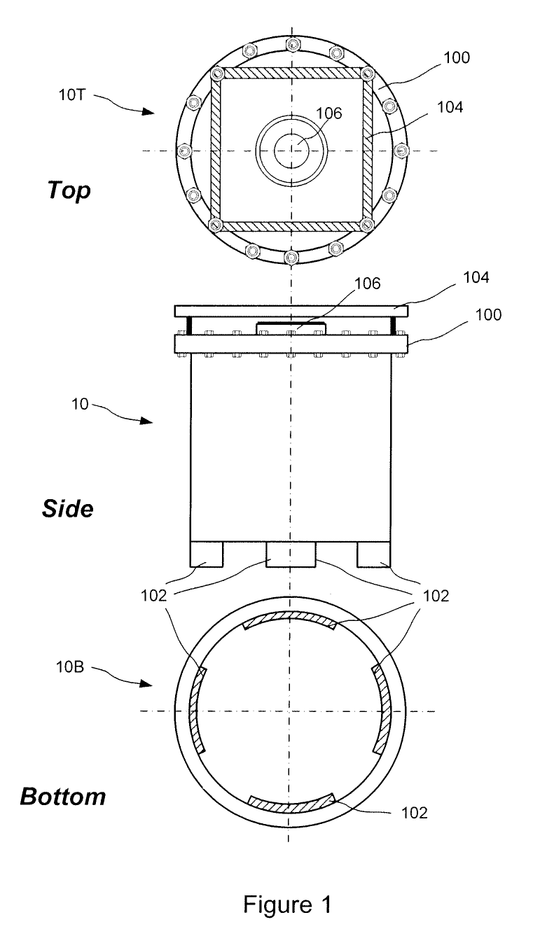

Certain embodiments of the invention provide a container that may be used to store, transport and dispense corrosive and otherwise hazardous chemical products without leakage or contamination of the products. In the latterly described example, certain embodiments of the invention are constructed using materials suitable for handling Iodomethane and an example of such a system will now be described by way of example. Referring to FIG. 1, a container 10 can be used for transporting, storing and dispensing hazardous chemicals that necessitate enhanced handling safeguards to prevent direct contact during manipulation and transportation of the container 10. In the described example, the container 10 can be used to store, transport, and supply agricultural equipment that dispenses and/or diffuses a fumigant that includes Iodomethane into soil.

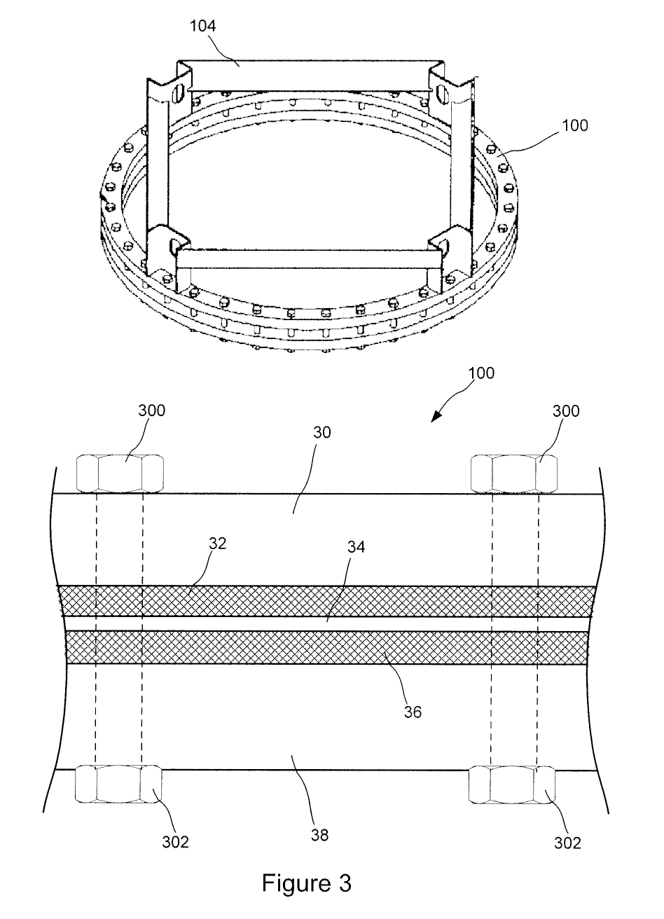

In the example, container 10 has a substantially cylindrical form that facilitates handling and storage. The cylindrical shape offers certain mechanical and functional advantages over other shapes, although it is contemplated that containers may be shaped according to requirements and/or preferences associated with modes of transportation and use. In certain embodiments, handling and storage of container 12 is facilitated by included components such as lifting bracket/device 104 and standoffs 102. Lifting bracket 104 is secured to a part of container 10 capable of sustaining stresses of loading anticipated during movement and manipulation of a fully charged container 10. Flange element 100 can include strength members and/or members used to clamp and seal the components of container 10 and can further provide suitable attachment points for bracket 104 (see also, FIG. 3 for detail).

In certain embodiments, top lifting device 104 may fastened to flange 100. Lifting device 104 facilitates hoisting and manipulation of the container 10 and can also serve to protect the top surface of container 100 from impact damage. In particular, top lifting device 104 can serve to protect valve assembly 106 from impact damage. Top lifting device 104 may be constructed from steel, aluminum, plastics or any material suited to the specific application.

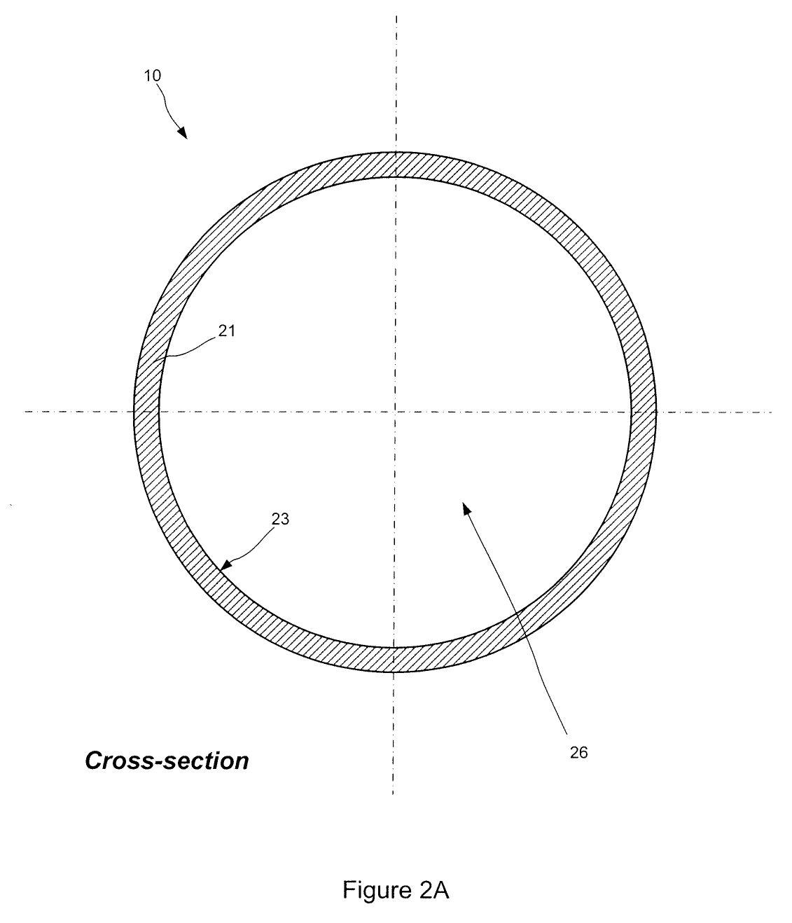

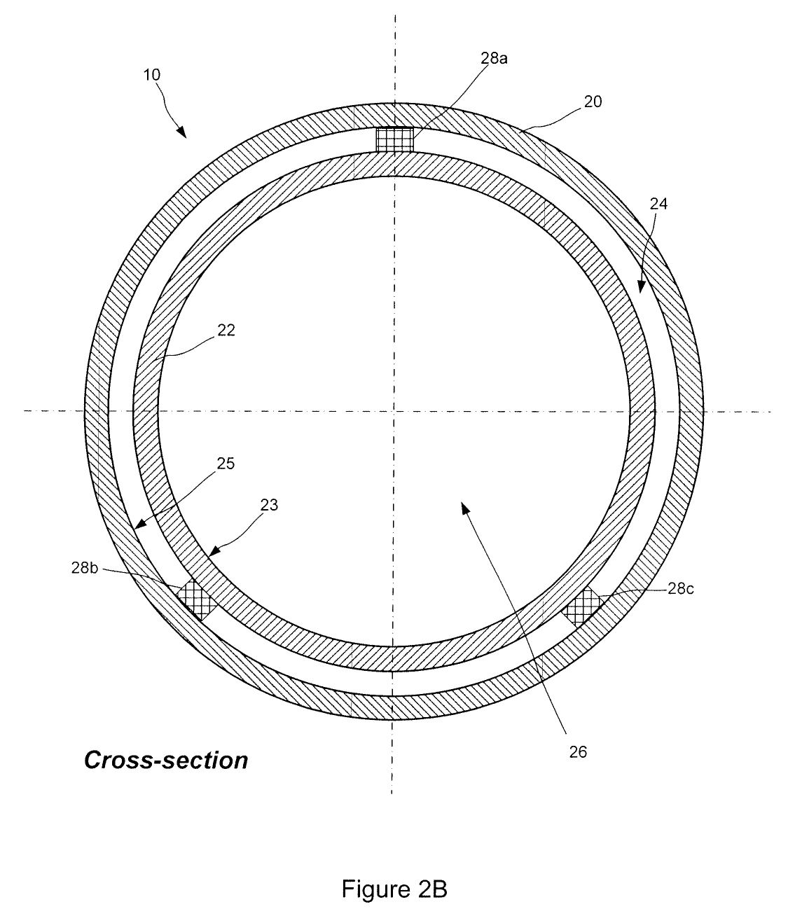

In certain embodiments, the container is adapted to be lifted, carried and manipulated by a fork lift, pallet jack and/or chain or strap apparatus. Container 10 may be manipulated by hoist or other lifting device using standoffs and/or attachment points may be provided at or near the base of container 10 to enable lifting, carrying and manipulation of container 10 by fork lift, pallet jack and/or by chain or strap apparatus. Standoffs 102 may be provided as feet on the base of container 10 and integrated with an outer surface or shell 10. Certain embodiments employ a multi-shell structure (see FIG. 2B) and it will be appreciated that feet can be bonded to the outer shell 20 of such containers. It will be appreciated however, that other methods of providing standoffs 102 can be used. For example, where outer shell 20 includes a steel component, standoffs can be welded, bolted or otherwise fastened to the steel component during manufacture. It is contemplated that grooves, slots, channels, eyes and/or other elements can be provided to guide and support straps and/or chains used to lift container 10.

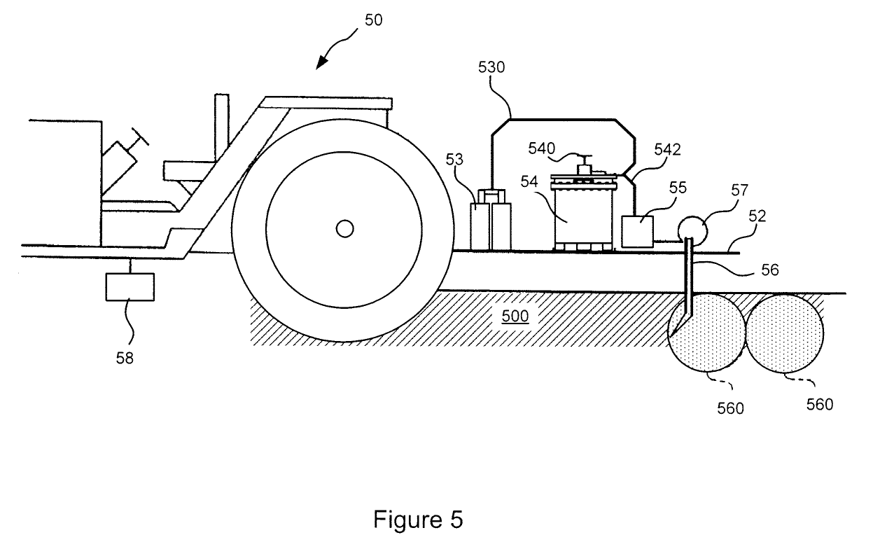

Container 10 is typically equipped with a valve assembly 106 that prevents loss during charging and discharging of chemical products from container 10. The components of the valve assembly can be selected from any suitable devices according to need or desire. In one example, assembly 106 comprises a Micro-Matic® Macro Valve Coupler with a draw tube can be used to obtain such lossless charging and discharging by ensuring that connections are properly established before material can be transferred to and from the container 10 (see also FIG. 5 and related descriptions). Furthermore, procedures for using the container 10 may include steps of flushing lines with an inert gas prior to disconnection and the assembly 106 may facilitate flushing to a holding tank and/or waste tank as necessitated by the specific application environment and materials carried in the container 10. Container 10 is typically charged at a chemical distribution facility, transported to a user of the chemical where it is connected to dispensing equipment. Dispensing equipment may be mounted on or drawn by a tractor or other agricultural vehicle and valve assembly 106 may be directly connected to the dispensing equipment.

Discharge of agricultural materials from container 10 can be controlled by pressurizing the contents of container 10 in order to drive fumigant or other chemicals from container 10 into dispensing equipment. Valve assembly 106 may comprise a regulator to limit the rate of discharge (and/or rate of charge during filling). Valve assembly 106 may also be configured to regulate pressure within container 10 to rated limits of the container 10. In certain embodiments, it is contemplated that regulation of pressure and charge/discharge rates will be performed using components external to container 10 and valve assembly 106. Due to the application and nature of the chemicals, other safeguards may be employed as necessitated by governmental, industry and other safety standards.

In certain embodiments, container 10 comprises a single drum or shell 21, as depicted in FIG. 2A. In some embodiments, container 10 comprises two or more concentric drums or shells 20 and 22 as depicted in FIG. 2B. The cylindrical drum configuration can be selected to obtain maximum allowable capacity under regulations such as DOT regulations for a Packaging Group 1 (PG1) drum for handling certain corrosive and otherwise hazardous materials. For reasons of economy of description, FIG. 2B is described here in more detail. However, it will be appreciated that many aspects of the containers in FIGS. 2A and 2B are coincident, or at least similar to some degree.

In the example depicted in FIG. 2B, container 10 comprises at least two shells 20 and 22, each shell 20 or 22 being capable of handling and containing the contents even if the other shell fails. In normal use, inner shell 22 receives and contains a chemical product within its interior space 26. Inner shell 22 is designed and constructed to handle the mechanical stresses associated with shipping and use of certain chemical products and has an inner surface that is substantially inert to these chemical products. Consequently, inner shell 22 alone is capable of containing the contents and can resist the corrosive effects of chemicals intended to be stored in the container 10 even if outer shell 20 sustains damage or the integrity of outer shell 20 is otherwise compromised.

In FIG. 2B, it will be noted that inner shell 22 is spaced apart from outer shell 20. Optionally, one or more spacing elements 28a, 28b and 28c may be provided in an interstitial space 24 between inner shell 22 and outer shell 20. In at least some embodiments, shells 20 and 22 have sufficient rigidity that spacing can be maintained without spacing elements 28a, 28b and 28c. Where present, spacing elements 28a, 28b and 28c are typically constructed from at least some of the same materials used to construct shells 20 and 22 and spacing elements 28a, 28b and 28c are typically manufactured to resist corrosion in the event of a failure of inner shell 22. Accordingly, spacing elements 28a, 28b and 28c may be constructed entirely from a material resistant to corrosion, or may be constructed from a structural member coated with a material resistant to corrosion. Spacing elements 28a, 28b and 28c may improve certain performance characteristics of the container; in one example, spacing elements 28a, 28b and 28c may be constructed and installed in a manner that improves shock absorption of container 10 in general, and inner shell 22, in particular.

Outer shell 20 is typically formed as a larger version of inner shell 22. Where provided, outer shell 20 has a primary purpose of containing chemical products in the event of failure of inner shell 22; failure of inner shell 22 typically arises from long-term exposure to corrosive materials, flaws in construction or mechanical damage incurred during handling. Outer shell can contain stored chemical products after catastrophic failure of inner shell 22 or after a lesser failure of shell 22 that produces a leak of chemical product into the space 24 between inner shell 22 and outer shell 20. In certain embodiments, outer shell 20 is constructed to withstand impacts, whether caused internally by failure of inner shell 22 or by external impact. It should be appreciated that both inner shell 22 and outer shell 22 are typically capable of withstanding external impacts. For example, outer shell 20 may be able to withstand impacts received during transportation and while deployed on moving farm vehicles. Inner shell 22 is typically constructed to absorb similar impacts in the event outer shell 20 is compromised. Thus, multi-shell embodiments comprising at least an inner shell 22 and an outer shell 20 can provide a fully redundant storage system capable of maintaining system integrity in the event of a failure of either shell 20 or 22.

Shells 20, 21 and 22 of FIGS. 2A and 2B may have closely matching structures, although in some embodiments, different construction methods may be employed for inner shell 22 and outer shell 20. For example, outer shell 20 may be provided with superior impact resistance relative to inner shell 22 because outer shell 20 is expected to receive rougher treatment than inner shell 22 during the lifetime of container 10. Likewise, inner shell 22 may include thicker layers of corrosion-resistant materials than outer layer 20 because inner shell 22 will be continuously and directly exposed to corrosive contents while outer shell 20 is expected to be exposed to corrosive contents only after failure of inner shell 22. In single shell embodiments, shell 21 is typically constructed to have adequate impact resistance and corrosion resistance properties.

In certain embodiments, shell 20, 21 and/or 22 may comprise at a least a layer constructed from a polymer material such as polyethylene. The polymer material is typically selected to meet mechanical specifications appropriate for the intended use of container 10 and sufficient to resist corrosion by the chemicals to be stored in the container. In one example, shell 20, 21 and/or 22 includes one or more layers of polymers that include high density polyethylene (HDPE). Layering may be employed to strengthen the shell structure, as will be described in more detail below. Layers may also be provided for properties such as resistance to corrosion and resistance to permeation by solvents or other chemicals. For example, a layer of HDPE fluoridated (to any level including levels 1, 3 and 5) material may be provided on surfaces 23 and 25 that are exposed, or likely to be exposed to corrosive contents. In certain embodiments, surfaces 23 and 25 may be coated with a polymer and/or a corrosive resistant resin. Other surfaces may be treated to obtain strength and impact resistance.

In one example, exterior shell 20 and/or 21 may be conditioned such that an interior layer is homogenously bonded to the poly liner. An inner poly layer may be up to ⅜″ thick with materials such as low density polyethylene (“LDPE”)-cross linked, high density polyethylene (“HDPE”), polypropylene (“PP”), or HDPE fluorinated up to level 5. The inner poly liner may be formulated with an additive package to ensure homogenous bond to the outer layer. The inner poly liner may be formulated to remove any dyes or colorant which could leach into the material in the tank. In certain embodiments a poly liner may be bonded to exterior of vessel. In certain embodiments inner shell 21 and/or 23 may be constructed with internal scavenger that is used for free iodine removal.

As noted above, container 10 may have elements used for manipulation, handling and other purposes. In embodiments that provide multiple shells, such elements may be constructed as integral parts of one or more shells 20 and 22. For example, outer shell 20 may include integrated feet 102 that can be molded with shell 20, welded to a steel layer of shell 20 (prior to coating, for example).

FIG. 3 shows flange 100 and lifting device 104 in isolation as well as a cross-sectional view of a segment of flange 100 of the container 10 depicted in FIG. 1. Flange 100 may be used to fix the configuration of inner and outer shells 20 and 22 relative to one another and may additionally lock lids or covers (not shown) of the inner and outer shells in place. The illustrated flange 100 comprises an upper annular portion 30, a lower annular portion 38 and an isolation spacer 34. A lip 36 of outer shell 20 is located between isolation spacer 34 and lower annular portion 38. A lip 32 of inner shell 22 is located between isolation spacer 34 and upper annular portion 30. Isolation spacer 34 is typically configured to prevent direct contact between lip 32 of inner shell 22 and lip 36 of outer shell 20. Upper annular portion 30, lower annular portion 38, isolation spacer 34 and lips 32 and 36 can be fastened together using a plurality of fasteners such as bolts 300 and nuts 302. Alternatively or additionally, upper annular portion 30, lower annular portion 38, isolation spacer 34 and lips 32 and 36 may be fastened together using one or more of riveting, welding, adhesive and other bonding techniques.

In one example, inner shell 22 may be completely isolated from contact with the outer shell 20 using a shock absorbing plastic molded isolation spacer 34 that, in some embodiments may be formed as two pieces for ease of installation. It will be appreciated that isolation spacer 34 maintains complete separation between inner and outer shells 20 and 22. Isolation spacer may also operate as a gasket and may be constructed with at least a portion that resists corrosion by chemicals stored in the container. Combinations of materials such as HDPE, fluoridated HDPE and for Teflon may be used to obtain resistance to corrosion.

In certain embodiments, container 10 may be instrumented to monitor and/or control conditions within the container interior 26. In one example, a pressure sensor is provided to monitor pressure within container interior 26 and may be coupled with a regulation system that prevents over-pressurization of container 10. In another example, instrumentation may detect compromise of inner shell 20, typically through the provision of one or more sensors in the storage area 26 and/or in the interstitial space 24. In the latter example, a variety of sensor types may be employed including chemical detectors, pressure sensors, temperature sensors, gas sensors, fluid detectors, strain gauges, light detectors, and so on.

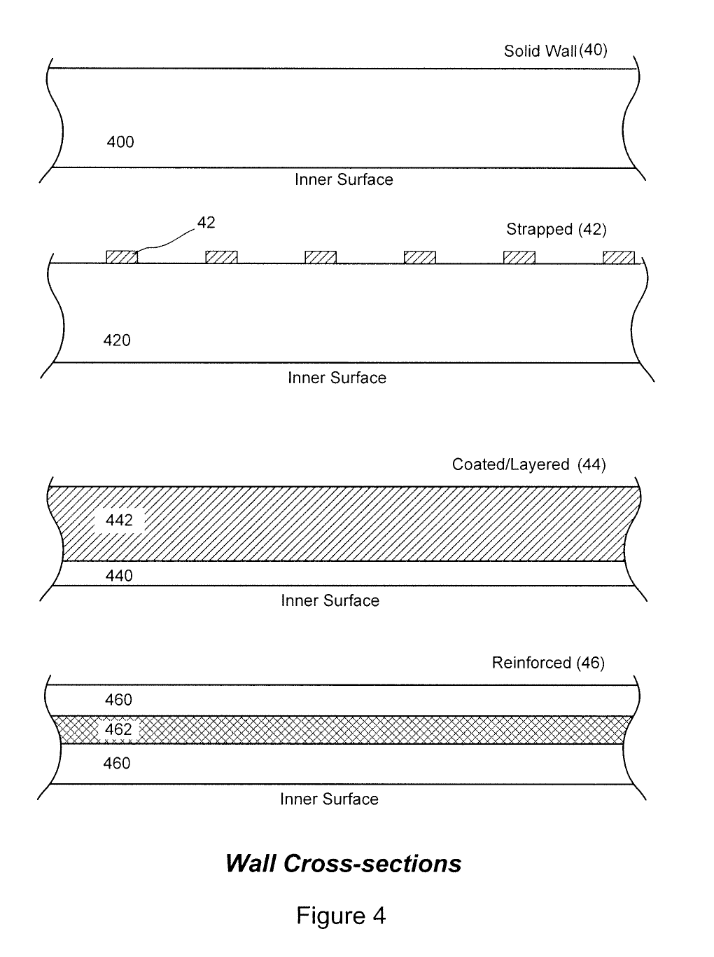

Turning now to FIG. 4, certain shell structures and materials used in constructing container 10 will be described in more detail. Many different wall structures including structures 40, 42, 44 and 46 are contemplated. In one example, shell 20, 21 and/or 22 has a solid wall 40. Container 10 is constructed with single shell 21, inner shell 22 and/or outer shell 20 can have walls constructed from a material 400 that resists corrosion, impact and that has sufficient strength to handle pressures and loading anticipated during use. In one instance, material 400 may comprise a form of polyethylene whose composition is selected to resist the corrosive action of the chemical to be handled, stored and transported using container 10.

In certain embodiments, plastics, including polyethylene, may not have sufficient tensile strength to maintain its integrity under desired operating pressures of container 10. Consequently, inner shell 21 and/or 22 may be strengthened using strapping 42. In the example where polyethylene is used as material 420, the strapping may be provided using steel, carbon fiber, Kevlar, composites, etc.

In certain embodiments, a multilayer wall 44 is provided that offers improved performance over single layer walls as described in the example above (e.g. single layer 40). Additional layers may be added to obtain a desired performance characteristic. To improve tensile strength and pressure ratings of container 10, a metal layer 442 may be included as illustrated in the example wall 44. In one example, a steel layer 442 may be coated with a corrosion-resistant material 440 such as the polyethylene material used in the examples above. The thickness and metallurgic characteristics of the steel 442 may be selected to obtain a suitable strength/weight ratio capable of supporting significantly higher container pressures. To improve resistance to corrosion, stainless steel may be employed and alloys of other metals may be used to obtain better corrosion resistance. In that regard, lighter metals, such as aluminum, may be used as a metal layer 442. In some embodiments, metal layer may be augmented or replaced by other structurally strong materials such as titanium, ceramics and composites. It may be necessary or beneficial to add layers between the polyethylene 440 and metal 442 layers to assist bonding, reduce interface issues such incompatible coefficients of expansion, for improved heat distribution, and so on. In one example, an embodiment uses a coating of polyethylene over a steel wall in order to obtain resistance to corrosion and mechanical strength sufficient to support an internal pressure of, for example, 120 PSI or more.

In certain embodiments, a multilayer wall 46 is provided that incorporates a strengthening member 462 within a polyethylene wall 460. In such embodiments, strengthening member 462 is typically provided as a fabric or mesh around which a polyethylene material 460 is molded. Strengthening member 462 may comprise a steel belt, carbon fibers, nylon mesh and so on.

It will be appreciated that the provision of a container according to certain aspects of the invention may enhance expected lifetime of the container 10 through increased corrosion resistance. The use of an inner shell 22 enclosed within an outer shell 20 may increase lifetime of the inner shell 22 by eliminating or reducing exposure to ultraviolet light, which can degrade certain materials fabrics with prolonged or long term exposure. As described above, inner shell 22 and outer shell 20 may differ in recognition of the difference in roles played by the shells 20 and 22. For example, outer shell 20 may be coated and/or painted on its external surface. External surfaces of outer shell 20 may also be encased in or bonded to a steel layer or other metallic layer for increased resilience to impact and for puncture resistance.

### Example

### Automated Diffusion System

A container according to certain aspects of the invention may be used in a system for diffusing a fumigant into soil. FIG. 5 depicts apparatus that injects Iodomethane as a fumigant into soil having the following characteristics: pH of 6-8, organic matter—1-3% by wt., % moisture—50-90 (sealed holding capacity). Apparatus includes a tractor 50 or other vehicle adapted to operate in an agricultural environment and a platform 52 towed by, or mounted on tractor 50. This configuration may, for example, apply to the preparation of a field for planting strawberries in soil.

Container 54 serves as a storage tank for the dispensing apparatus and is mounted on platform 52. Platform 52 is configured to retain container 54 in position during operation and may comprise a tool bar or other similar structure attached to, for example, tractor 50. Alternatively, container 54 may be transported in any other suitable manner, such as by a pick-up truck. Material stored in container 54 flows through tubing 542 into a reservoir 55. A one-way valve or switch 540 may be coupled to a macro valve coupler or other valve at the outlet of container 54 and allows material to fill reservoir 55. Tubing 542 may include a conduit of compressed gas to the container 54. A source of compressed gas 53 is typically used to force Iodomethane or other material from container 54. The same or a different source of compressed gas 53 may be connected by tubing 530 to reservoir 55 so that materials in the reservoir 55 may be pressurized further, prior to diffusion. It will be appreciated that the compressed gas provided to container 54 and reservoir 55 may be pressurized to different pressure levels. The compressed gas is typically compressed nitrogen, but other non-reactive gas may be used. Solenoid switches (not shown) may be provided to control the flow of compressed gas in line 542 which is connected to container 54. Similarly, solenoid switches (not shown) can be coupled to tubing 530 to control the flow of compressed gassed therethrough to reservoir 55. One skilled in the art will recognize that the same result may be achieved by a pump, the pump being a relatively accurate pump. Thus, injections of material into the soil in accordance with the present invention may be made with a positive displacement pump, but of course diaphragm, roller, impeller or other pumps may also be used.

The apparatus is positioned at a location in the treatment area 500 whereby shanks 56 (one visible in FIG. 5) are located in the same plane at a depth of 10 inches in a soil bed 38 inches wide, the shanks 56 being spaced 24 inches apart. Based upon information previously inputted into computerized controls of the apparatus, an amount of Iodomethane is drawn from container 54 for injection into the soil by all the shanks 56 and placed in a reservoir 55. Following opening a solenoid switch at the reservoir 55, a predetermined amount of Iodomethane then flows through tubing by means of compressed gas to a manifold 57 which distributes the Iodomethane equally among shank tube lines, each of which has a nozzle associated with each of the shanks 56. In one example, 1.5 ml of Iodomethane is injected from each nozzle into soil 500 where the Iodomethane immediately vaporizes into a gas and creates a diffusion pattern in the soil that is either spherical or elliptical in shape, having an effective treatment diameter of about 24 inches. Reservoir 55 may be precharged with exactly the amount of Iodomethane required to supply each shank with the 1.5 ml of Iodomethane although, in certain embodiments, reservoir 55 may hold significantly more Iodomethane than required and reservoir 55 may include a dispensing system that controls the amount of Iodomethane transferred to manifold 57 and thence to shanks 56. In the latter configuration, reservoir 55 may act as a buffer between container 54 and dispensing mechanism, thereby enabling a difference between pressure within container 54 and the pressure needed to dispense the Iodomethane.

In the example, fumigant delivered from container 54 and dispensed through one of the shanks 56 provide a series of individual injection points that will have a maximum distribution or diffusion pattern 560 in the soil of the applied chemical or chemicals that, if desired, touches or overlaps with diffusion patterns from adjacent injections. Gas sensors located near the nozzles of the tube shank lines determine when all the Iodomethane has been expelled from the shank tubing lines and the solenoid switch opening the reservoir 55 is closed. The apparatus is then moved a desired distance in a straight path to a second position whereat a second injection of Iodomethane is carried out by the sequence of Iodomethane transfer and valve openings discussed above.

In accordance with certain aspects of the present invention, the quantity of material needed for a single injection may be drawn from some combination of container 54 and reservoir 55. The exact amount drawn is determined by the target rate to be applied/acre taking into consideration the ground speed of the tractor 50. Ground speed may be determined by global positioning system or radar device 58 mounted on tractor 10 and transmitted to a computer 160 that regulates the feed of material from container 54 to manifold 57. The spacing of individual injection points may be as much as 60 inches apart.

Tubing 530 and/or 542 that contacts the material stored in container 54 is selected based on its compatibility with the material. In this regard, when injecting iodomethane into soil in accordance with the present invention, tubing material which is durable and will not corrode is typically used, as one skilled in the art would recognize. For example, when injecting iodomethane, the tubing may be stainless steel, a perfluoroelastomer or fluoroelastomer, such as Kalrez® or Viton®, respectively, both of which are available from Du Pont Dow Elastomers, LLC of Wilmington, Del.

Compounds stored in container 54 and injected into the soil in accordance with the present invention include iodomethane, but the present invention is not limited to the storage, transportation and application of iodomethane or even fumigants. A container constructed according to certain aspects of the invention may be used with other compounds, such as fertilizers, biologicals, and non-fumigant pesticides, either alone or in combination with Iodomethane. For example, the apparatus and method described may be used to introduce the following chemical and biological materials into the soil: the fumigant chloropicrin (trichloronitromethane) available from Niklor Chemicals Mojave of Long Beach, Calif.; the fumigant Telone-35 (1,3-dichloropropene and 35% chloropicrin) available from Dow AgroSciences of Indianapolis, Ind.); the fumigant propargyl bromide (3-bromopropyne) available from Albermarle Corporation of Baton Rouge, La.; the liquid biological nematicide Ditera (a natural product from the hyphomycete fungus Myrothecium spp. composed primarily of proteins, sugars and lipids) available from Valent BioSciences of Libertyville, Ill.; the liquid Plant Pro 45 (3% iodine based ingredient) available from Ajay North America of Powder Springs, Ga.; the liquid fertilizer CAN-17 (calcium aluminum nitrate 17% solution) available from Prodica of Brea, Calif.; the liquid fertilizer UN-20 (nitrogen urea 20% solution) available from, among others, Soil Serve of Salinas, Calif.; and liquid Bacillus subtilus suspended in aqueous solution available from Agra Quest of Sacramento, Calif. Other chemical and biological materials such as Pseudomonas sp. suitable for injection into soil in accordance with the present invention will be apparent to one skilled in the art. The material introduced into the soil in accordance with the present invention may be either a liquid or gas.

### Container Reuse

As discussed above, containers provided according to certain aspects of the invention may be cyclically reused over the lifetime of the container and/or the lifetime of a certification of the container. In one example, a container may be charged with a material at a chemical manufacturing or distribution point and transported to a location, such as a farm, where the material is dispensed. The container is typically mounted on dispensing apparatus and, when substantially discharged, returned to the manufacturer/distributor for recharging. It is contemplated that, before return for recharging, the container may be removed, stored and subsequently remounted on dispensing apparatus one or more times.

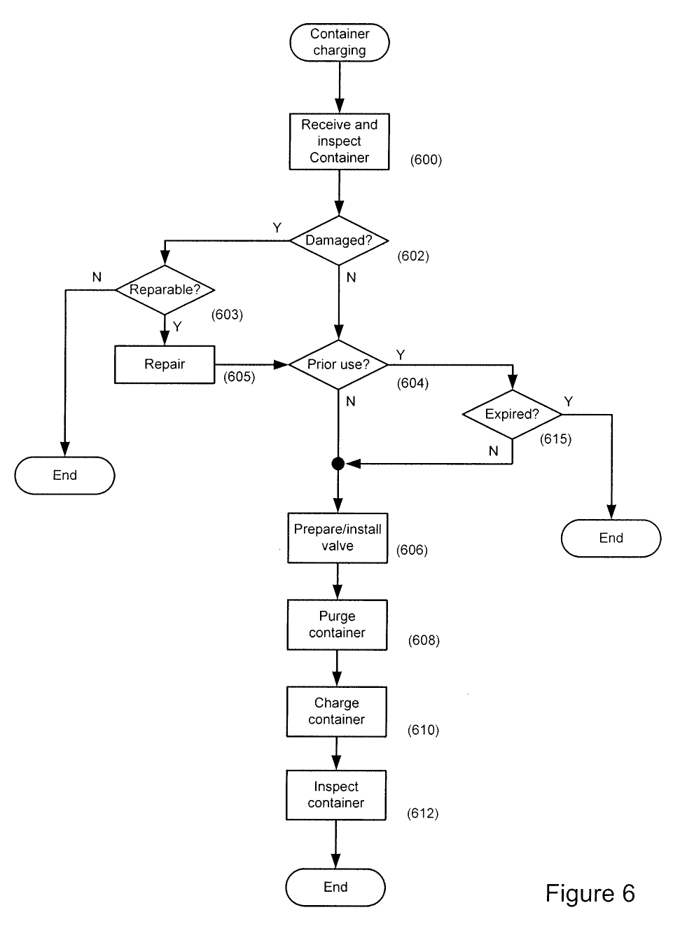

The flowchart provided in FIG. 6 depicts a method for handling a container during charging, wherein the container is constructed according to certain aspects of the invention. The method can be used to protect the container from contamination and permit delivery of a contaminant free product. It will be appreciated that containers according to certain aspects of the invention, such as those described above, are intended to be certified and/or approved for use by a government agency, such as the U.S. Department of Transportation and that such certification is typically required prior to transport of materials such as methyl iodide and/or chloropicrin mixtures. Additionally, the containers may have an associated expiration date (a test date) after which date, a container is required to be recertified before further use.

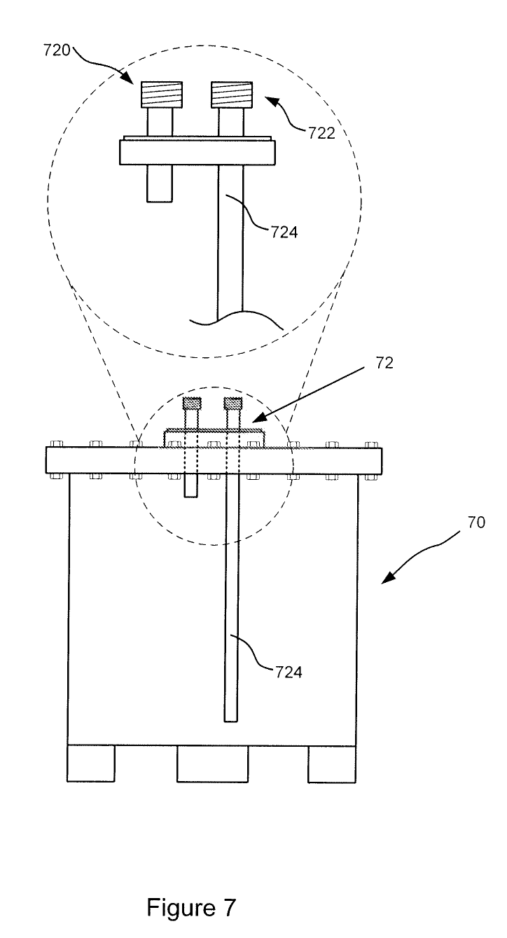

With reference also to FIG. 7, a container is received and inspected at step 600. Containers are inspected for damage. Inspection may include visual inspection, pressure testing and/or use of a chemical detector. An initial visual inspection can reveal outward damage and evidence of chemical leakage and is typically performed to reduce risk of exposure to hazardous contents. The visual inspection may include a weighing of previously-used containers. The weight of a container can be compared with the known weight of the fully charged container and the known weight of the container when empty. This information may be used to determine if any material remains in the container and/or whether a customer credit should be made for unused material. Table 1 shows the specific weight of certain formulations of Iodomethane (such formulation referred to herein as a Midas formulation).

TABLE 1

| Formulation | Specific Gravity |
|---|---|
| Midas 98:2 | 2.27 |
| Midas 50:50 | 1.90 |
| Midas 33:67 | 1.84 |

Calculation of a quantity of material typically includes multiplying the total net weight needed by the percentage of the Midas formulation for each material added to the container 70. This calculation can be made while charging a container and while determining remaining material in a returned container.

The visual inspection may also include recordation of identifying information. Containers typically carry one or more identifiers such as a serial number, a batch number, a test/certification number, a test/certification date and other identifying information that enables an inspector to determine the remaining lifespan of the container, recall notices, prior content, number of charging cycles experienced by the container and other historical information associated with the container. Electronic identification may be obtained by scanning barcodes, capturing information stored on an RFID or other electronic identifier. Identifying information can include an identification of the formulation of any material remaining in the container. Typically, remaining materials in the container are then removed. The removal procedure may include pressurizing the cylinder with nitrogen to expel the contents of the container and force such contents through a 5 micron filter into a holding tank specific to the identified formulation. New, refurbished and/or repaired containers are typically flushed to remove slag or other manufacturing debris before filling.

The recovery line that transmits the content to the filter can be equipped with a Coriolis mass flow meter capable of measuring the density of the returned material to 0.1lb/ft³. The density of the material can be cross-referenced to expected densities of the identified formulation in order to ascertain if the material has been adulterated with other materials and, therefore, requires special handling.

After flushing, the pressure within the container may be monitored for indications of leakage. In some embodiments, a vacuuming step may be employed in addition to, or as an alternative to the flushing step. For example, vacuuming a new or refurbished container may be performed prior to installation of valve or valve coupling components. In certain embodiments, valve components are removed to enable further inspection of the container, including inspection of the inner shell for integrity.

At step 602, the results of inspection may indicate that the container is damaged or may raise the suspicion of damage. If damage is present, then it is determined at step 603 if a repair is possible. If not, the process is terminated. A repair may be performed at step 605. Repair can include replacement of fasteners, handling mechanisms and valves. Structural repair of the inner and outer shells may not be possible or desirable. Repair can include an evaluation of the container 70 for cleanliness and a check of the valve mechanism 72 for clogging, depositions, plugging, etc. Repair typically includes verification of function of the valve mechanism 72 and other hardware. The process continues at step 604 if a successful repair is accomplished. At step 604, the history of the container is considered. Regulations may require detailed inspection, refurbishment and/or recertification of a container after a predetermined length of service and/or completion of a designated number of cycles. The number of cycles and/or term of service may be altered based on mixed use. Term of service may be expressed as a “test date” that identifies the end of term of the container 70. Use for various corrosive materials may reduce the term or number of cycles, whether or not required by government regulation. If the number of cycles or a maximum period of service has not been reached, the process continues at step 606. Otherwise, the current process may be terminated and the container removed for further processing that can include depressurization, cleaning, and recertification according to DOT regulations. For example, in the United States, an out-of-date container 70 is typically subjected to a permanent expansion pressure test specified in an appropriate section of Code of Federal Regulations. This latter testing must be performed by a certified testing facility and, if the container 70 passes, it is stamped with the new test expiration date.

Valve mechanisms are optionally installed at step 606. In certain embodiments, valve mechanisms 72 are not removed except for scheduled maintenance and/or for repair. Valve mechanism 72 typically comprises an entrance valve 720, an exit valve 722 and a dip pipe/tube (a straw) 724 constructed from copper, natural polyethylene or other suitably inert material. The mechanism depicted in FIG. 7 is simplified and stylized to assist understanding. The length of the dip tube 724 is selected to enable draw down of as much product in the charged container 70 as possible, thereby ensuring that minimal residue is left in the container 70. Installation of the valve mechanism 72 typically includes purging the container 70 with nitrogen at step 608 to remove water vapor that may be trapped in the container 70. A typical purge involves a 30 second cycle of nitrogen. After purging, the exit valve 722 may be closed to allow a minimum nitrogen pad/blanket to develop in the container before the entrance valve 720 is closed. A typical nitrogen pad exerts 10-20 psi. Installation of the valve mechanism 72 typically includes an inspection, including a check for leaks using a Snoop device or a comparable leak detection device, examples of which are commercially available and known to those with skill in the art. Typically, a minimum nitrogen pad is maintained in the container 70 at all times while in service. It will be appreciated that tubing and other mechanisms may be flushed using a compressed gas after completion of charging and that dispensing equipment can be flushed in a similar manner after use.

At step 610, the container 70 is charged with a desired formulation of chemicals. The formulation may be measured by weight using a calculation similar to that described above in connection with Table 1. It will be appreciated that tubing and other mechanisms may be flushed using a compressed gas after completion of charging and that dispensing equipment can be flushed in a similar manner after use. A final inspection at step 612 may be performed immediately upon completion of charging and/or immediately prior to shipping. The container 70 is checked for labeling, damage and leaks. The weight of the container may be checked to verify the operation of valve mechanism 72. Final inspection is typically governed by regulations and/or guidelines, including those promulgated by a relevant Department of Transportation.

In addition to the steps described, certain additional steps may be performed in various circumstances. In particular, when a container 70 is used with different products, cleaning steps may be required. For example, containers that have been used with methyl bromide/chloropicrin can safely be converted for Iodomethane use after proper cleaning. Cleaning can include the steps of purging container 70 as described above, depressurizing container 70, emptying any foreign material from container 70, and inspecting container 70. Inspection may reveal loose scale on the sides or bottom that can be cleaned using shot blasts, water blasts and other appropriate means to loosen and remove the scale and other debris from the container 70. Loosened scale and debris can be removed by vacuum or by flushing all loosened debris and water from the cylinder.

### Additional Features

Certain additional features, characteristics and attributes of containers constructed according to certain aspects of the invention can be identified. In certain embodiments, one or more of the shells 20, 21 and/or 22 (see FIGS. 2A and 2B) have openings provided at opposite ends of the shell 20, 21 and/or 22 to facilitate conditioning of the interior. In one example, openings are provided in the curved wall of a shell 20, 21 and/or 22 with an angular separation of 180 degrees. In another example, openings can be provided on the top and bottom surfaces of substantially cylindrical shell 20, 21 and/or 22.

Containers provided according to certain aspects of the invention may be fitted with pumping, regulation and metering systems that can be used to control output of the system. In one example, a container 54 (see FIG. 5) may be coupled to a dispensing mechanism that provides measured amounts of material (e.g. fumigant) to obtain, for example, a predetermined area and/or depth of soil 560 to be treated. A pump and/or regulator may be used to provide a level of feed to a holding tank 55 provided on the system, where level of feed can be measured as some combination of rate of flow and pressure. In that regard, a metering system may be employed to provide a feedback loop for controlling the flow of material from the container 54.

In certain embodiments, a container 10 (see FIG. 1) may comprise internal baffles to prevent or reduce undesired flow, agitation and/or circulation of the material within the container. Some containers may comprise a full port, self cleaning valve system to minimize pressure drop. In some embodiments, the container may have a protective collar that provides additional protection to the valve assembly. The valve assembly may comprise interchangeable components that are selected to address application-specific requirements.

In certain embodiments, the container may be equipped with one or more identification and/or tracking systems. Identification of a container can be accomplished using machine readable patterns such as barcodes, radio-frequency IDs (passive or active) or using a computing device that communicates wirelessly in order to respond to interrogation of a tracking system. In one example, a GPS tracking system may monitor system location and/or status whereby the GPS tracking system receives GPS coordinates from a device attached to the container or from a detector that identifies the container through triangulation of a signal received from an RFID or other device attached to the container. For example, a passive RFID transponder may be detected upon arrival at, or departure from a shipping and/or receiving location, as well as intermediate points in shipment.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a container for transporting, storing and using hazardous chemical compounds. Some of these embodiments comprise an inner shell constructed from one or more layers of material and having an inner surface of plastic that is resistant to corrosion by Group 1 chemicals. Some of these embodiments comprise an outer shell having an inner surface resistant to corrosion by Group 1 chemicals. In some of these embodiments, the inner shell and outer shell are constructed such that the outer shell contains any leakage from the inner shell. Some of these embodiments comprise a valve. Some of these embodiments comprise a pressure sensor. In some of these embodiments, wherein the outer shell includes a pallet friendly. In some of these embodiments, wherein the container is rechargeable and reusable.

Certain embodiments of the invention provide systems and methods for transporting and dispensing hazardous chemicals using a container resistant to the detrimental effects of the chemicals. In some of these embodiments, the container comprises a first shell configured to contain a corrosive chemical, a second shell surrounding the first shell and a spacer that maintains separation of the first and second shells. Some of these embodiments comprise a valve through which the corrosive chemical is discharged under pressure from the container. In some of these embodiments, an interstitial space is provided between first and second shells. In some of these embodiments, the spacer seals the interstitial space. In some of these embodiments, the second shell is configured to contain any of the corrosive chemical that escapes the first shell within the interstitial space.

In some of these embodiments, the first and second shells are constructed such that the second shell contains any leakage from the inner shell. In some of these embodiments, at least one of the first and second shells is constructed entirely from a polymer material resistant to corrosion by the chemical. In some of these embodiments, the polymer material includes a polyethylene. In some of these embodiments, the chemical includes a fumigant. In some of these embodiments, at least one of the first and second shells comprises a plurality of layers. In some of these embodiments, the at least one shell has an innermost layer configured to contact the chemical. In some of these embodiments, the innermost layer is constructed from a polymer material resistant to corrosion by the chemical and wherein the chemical includes a fumigant. In some of these embodiments, the plurality of layers includes a metallic layer coated with the polymer material.

In some of these embodiments, the valve comprises an entrance valve coupled to a source of a compressed inert gas, an exit valve coupled to a dispensing system and a straw extending into the first shell, wherein the chemical is extracted from the first shell through the straw under pressure of the compressed inert gas. In some of these embodiments, the outer shell includes a base adapted for securing the container during transport and use. In some of these embodiments, the use includes discharging the content into soil using agricultural equipment. Some of these embodiments comprise a lift bar configured for safely transferring or docking the container with agricultural equipment.

Certain embodiments of the invention provide systems and methods that comprise a reusable tote having an inner shell configured to contain a hazardous fumigant and an outer shell separated from the inner shell by an interstitial space and at least one spacer. In some of these embodiments, the spacer, the inner shell and the outer shell are secured using a flange. Some of these embodiments comprise a diffusion device that extracts the fumigant from the reusable tote under pressure and diffuses the fumigant into soil in a desired pattern. In some of these embodiments, the inner container comprises one or more layers of material, including an inner polyethylene surface that is resistant to corrosion by Group 1 corrosive chemicals. In some of these embodiments, the diffusion device is coupled to a vehicle and the reusable tote is mounted on the vehicle during use.

Certain embodiments of the invention provide systems and methods for safely transporting Packing Group I chemicals. Some of these embodiments comprise the step of placing the chemicals in a tank having an inner and an outer container for storage and delivery of Packing Group I chemicals. In some of these embodiments, the inner container has a first lip and the outer container has a second lip. Some of these embodiments comprise the step of securing the lips of the inner and outer containers with a flange, thereby separating the inner container and the outer container and preventing contact between the inner and outer container.

Certain embodiments of the invention provide chemical tote. Some of these embodiments comprise a tank having a plurality of layers. In some of these embodiments, the layers include an inner surface layer that comprises a polymer resistant to corrosive effects of a chemical stored by the tank. Some of these embodiments comprise a valve assembly configurable to seal the tank and to maintain the chemical under pressure when closed. In some of these embodiments, the valve assembly is configurable to permit charging of the shell with the chemical in one open mode and to control rate of discharge of the chemical in another open mode. Some of these embodiments comprise a flange attached to a top surface of the tote and surrounding the valve assembly. In some of these embodiments, the flange protects the valve assembly. In some of these embodiments, a collar substantially surrounding the valve assembly protects the valve assembly. In some of these embodiments, the flange includes a lifting bar that engages with lifting equipment used to manipulate the tote. In some of these embodiments, the container is configured to mounted on a dispensing system used to treat soil with the chemical.

In some of these embodiments, the plurality of layers includes a stiffening layer coated with a chemical resistant polymer. In some of these embodiments, the stiffening layer comprises a steel shell. In some of these embodiments, the stiffening layer comprises a composite layer. In some of these embodiments, the chemical includes a Packing Group 1 chemical. In some of these embodiments, the chemical resistant polymer includes a polyethylene. In some of these embodiments, each layer comprises the chemical resistant polymer. In some of these embodiments, the stiffening layer comprises a fabric that increases tensile strength of the tank. In some of these embodiments, the fabric includes one or more of PTFE, metal and composite. In some of these embodiments, the stiffening layer hardens the tank and improves impact resistance.

In some of these embodiments, the chemical includes methyl iodide. In some of these embodiments, the valve assembly comprises an entrance valve coupled to a source of a compressed inert gas, an exit valve coupled to a dispensing system and a straw extending into the first shell. In some of these embodiments, the chemical is extracted from the first shell through the straw under pressure of the compressed inert gas. In some of these embodiments, the valve is configurable to maintain the chemical under a pressure of at least 400 pounds per square inch. In some of these embodiments, the valve is configurable to maintain the chemical under a pressure of greater than 400 pounds per square inch. In some of these embodiments, the valve is configurable to maintain the chemical under a pressure of at least 250 pounds per square inch. Some of these embodiments comprise an outer shell, separated from and surrounding the tank, wherein an interstitial space between the tank and the outer shell is sealed, thereby enabling the outer shell to prevent escape of the chemical upon failure of the tank.

Some of these embodiments comprise a plurality of spacers within the interstitial space. In some of these embodiments, one of the spacers is cinched between the shells by the flange. In some of these embodiments, the spacers maintain separation between the first and second shells. In some of these embodiments, the outer shell is sealed when the chemical is stored by the container thereby preventing loss of the chemical from the container when the integrity of the inner shell is compromised. Compromise may result from corrosion, impact damage and/or fatigue caused by cycles of pressurization. In some of these embodiments, the resistant polymer comprises polyethylene and the chemical includes methyl iodide. In some of these embodiments, at least the outer shell comprises a steel shell having an inner surface coated with the chemical resistant polymer on an inner surface of the steel shell, wherein the outer shell resists impacts to the chemical tote and has sufficient strength to contain any escaped pressurized chemical leaked from the tank. The outer shell can withstand at least the rated pressure of the inner shell, tank or container. In some of these embodiments, the strengthening material comprises one or more of steel, a composite and PTFE.

Some of these embodiments comprise an outer shell, separated from and surrounding the tank. In some of these embodiments, an interstitial space between the tank and the outer shell is sealed, thereby enabling the outer shell to prevent escape of the chemical upon failure of the tank. In some of these embodiments, the outer shell comprises a steel shell having an inner surface coated with the chemical resistant polymer on an inner surface of the steel shell. In some of these embodiments, the outer shell resists impacts to the chemical tote and has sufficient strength to contain any escaped pressurized chemical leaked from the tank.

Certain embodiments of the invention provide a container for transporting and dispensing chemical products. Some of these embodiments comprise an outer shell having at least an inner surface of the outer shell comprises a polymer that is resistant to corrosive effects of a chemical carried by the container. Some of these embodiments comprise an inner shell defining a storage chamber of the container. In some of these embodiments, the inner shell is provided within the outer shell and spaced apart from the inner surface of the outer shell, thereby creating an interstitial space between the inner and outer shells. In some of these embodiments, at least an inner surface of the inner shell comprises the resistant polymer. Some of these embodiments comprise a valve assembly configurable to seal the storage chamber and to maintain the chemical under pressure within the inner shell when closed, wherein the valve assembly is configurable to permit charging of the shell with the chemical in one open mode and to control rate of discharge of the chemical in another open mode. In some of these embodiments, the container is configured to directly supply the chemical to a dispensing system used to treat soil with the chemical.

Some of these embodiments comprise a plurality of spacers within the interstitial space. In some of these embodiments, the spacers maintain separation of the first and second shells. In some of these embodiments, the surfaces of the storage chamber and the interstitial space comprise the resistant polymer. In some of these embodiments, the outer shell is sealed when the chemical is stored by the container thereby preventing loss of the chemical from the container when the integrity of the inner shell is compromised. In some of these embodiments, the inner shell is constructed entirely from the polymer. In some of these embodiments, the polymer includes a polyethylene. In some of these embodiments, the chemical includes methyl iodide. In some of these embodiments, the outer shell comprises a strengthening layer coated with the resistant polymer.

In some of these embodiments, the valve assembly comprises an entrance valve coupled to a source of a compressed inert gas, an exit valve coupled to a dispensing system and a straw extending into the first shell. In some of these embodiments, the chemical is extracted from the first shell through the straw under pressure of the compressed inert gas. In some of these embodiments, the inert gas is nitrogen. In some of these embodiments, the valve is configurable to maintain the chemical at a selected pressure. In one example of an embodiment, the selected pressure is at least 200 pounds per square inch. In one example of an embodiment, the selected pressure is at least 400 pounds per square inch. In one example of an embodiment, the selected pressure is greater than 400 pounds per square inch.

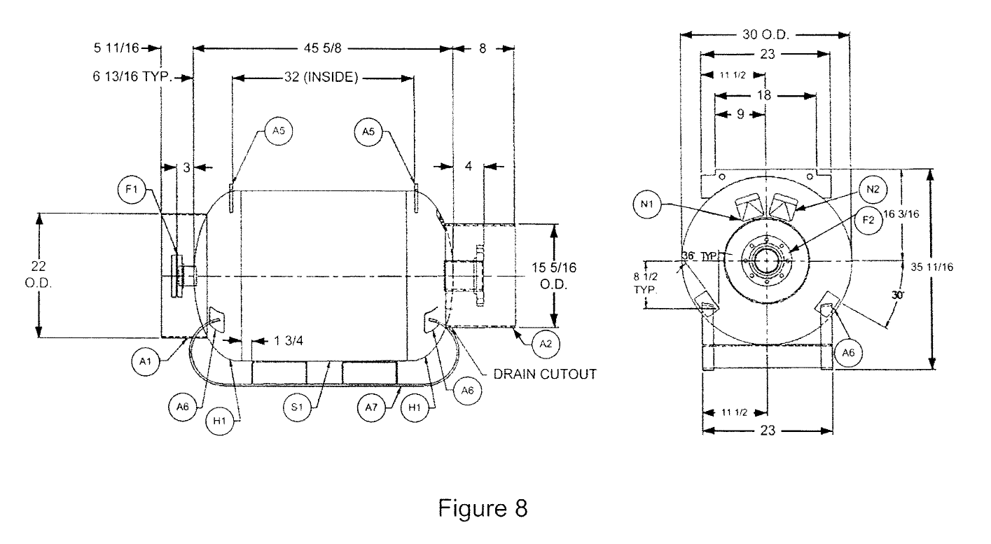

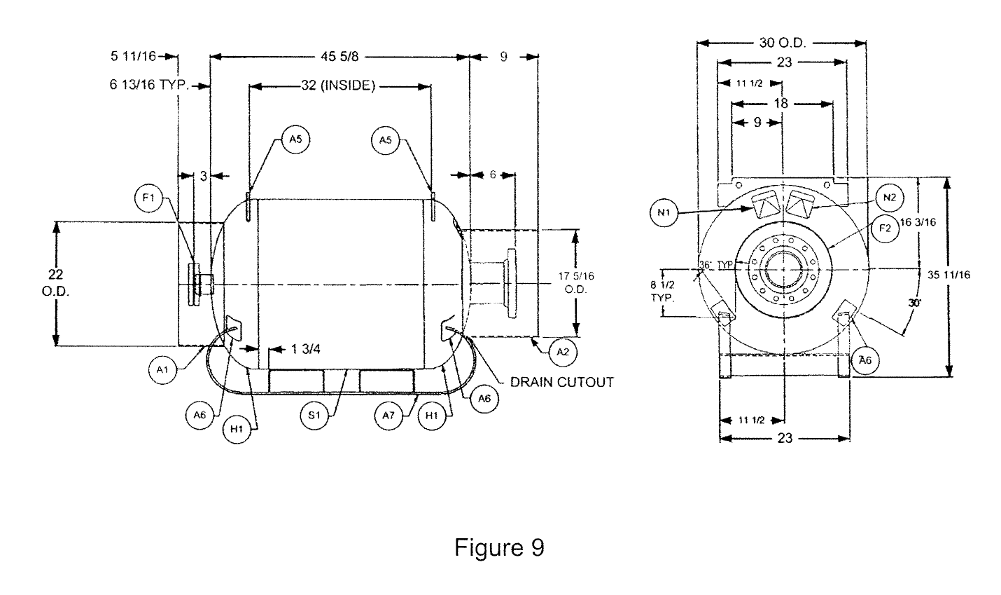

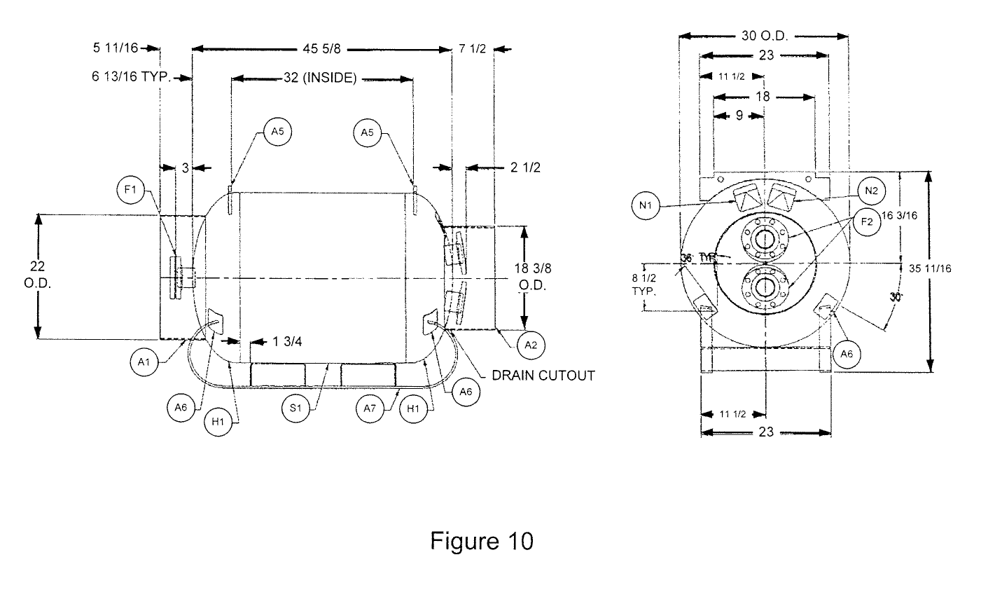

Although the present invention has been described with reference to specific exemplary embodiments, it will be evident to one of ordinary skill in the art that various modifications and changes may be made to these embodiments without departing from the broader spirit and scope of the invention. FIGS. 8, 9 and 10 are provided as examples of embodiments that provide containers in accordance with certain aspects of the invention. Accordingly, the specification and drawings are to be regarded in an illustrative rather than a restrictive sense.

What is claimed is:

1. A chemical tote, comprising:
a tank having a plurality of layers including an inner surface layer that comprises a polymer resistant to corrosive effects of a chemical to be stored in the tank;
a valve assembly configurable to seal the tank and to maintain the chemical under pressure when closed, wherein the valve assembly is configurable to permit charging of the tank with the chemical in one open mode and to control rate of discharge of the chemical in another open mode; and
a flange provided on a top surface of the tote and surrounding the valve assembly,
wherein the flange includes a lifting bar that engages with lifting equipment used to manipulate the tote, and
wherein the container is configured to mounted on a dispensing system used to treat soil with the chemical.

2. The chemical tote of claim 1, wherein the plurality of layers includes a steel shell and the inner surface layer is provided as a coating of a chemical resistant polymer on an inner surface of the steel shell.

3. The chemical tote of claim 2, wherein the chemical includes a Packing Group 1 chemical, and wherein the chemical resistant polymer comprises polyethylene.

4. The chemical tote of claim 1, wherein the chemical includes a Packing Group 1 chemical, and wherein the chemical resistant polymer comprises polyethylene.

5. The chemical tote of claim 4, wherein each of the plurality of layers comprises the chemical resistant polymer and at least one layer is formed about a fabric that increases tensile strength of the tank.

6. The chemical tote of claim 1, wherein the chemical to be stored includes methyl iodide.

7. The chemical tote of claim 1, wherein the valve assembly comprises:
an entrance valve coupled to a source of a compressed inert gas;
an exit valve coupled to a dispensing system; and
a straw extending from the exit valve into the tank, wherein the chemical is extracted from the tank through the straw under pressure of the compressed inert gas.

8. The chemical tote of claim 7, wherein the valve is configured to store the chemical in the tank under a pressure of at least 400 pounds per square inch.

9. The chemical tote of claim 8, further comprising an outer shell, separated from and surrounding the tank, wherein an interstitial space between the tank and the outer shell is sealed, thereby enabling the outer shell to prevent escape of the chemical upon failure of the tank.

10. The chemical tote of claim 9, wherein the outer shell comprises a steel shell having an inner surface coated with the chemical resistant polymer on an inner surface of the steel shell, wherein the outer shell resists impacts to the chemical tote and has sufficient strength to contain any escaped pressurized chemical leaked from the tank.

11. A container for transporting and dispensing chemical products, comprising:
an outer shell having at least an inner surface of the outer shell comprises a polymer that is resistant to corrosive effects of a chemical carried by the container;
an inner shell defining a storage chamber of the container, wherein the inner shell is provided within the outer shell and spaced apart from the inner surface of the outer shell, thereby creating an interstitial space between the inner and outer shells, and wherein at least an inner surface of the inner shell comprises the resistant polymer; and
a valve assembly configurable to seal the storage chamber and to maintain the chemical under pressure within the inner shell when closed, wherein the valve assembly is configurable to permit charging of the shell with the chemical in one open mode and to control rate of discharge of the chemical in another open mode,
wherein the container is configured to directly supply the chemical to a dispensing system used to treat soil with the chemical.

12. The container of claim 11, further comprising a plurality of spacers within the interstitial space, wherein the spacers maintain separation between the first and second shells.

13. The container of claim 12, wherein the outer shell is sealed when the chemical is stored by the container thereby preventing loss of the chemical from the container when the integrity of the inner shell is compromised.

14. The container of claim 11, wherein the resistant polymer comprises polyethylene.

15. The container of claim 14, wherein the chemical includes methyl iodide.

16. The container of claim 14, wherein at least the outer shell comprises a steel shell having an inner surface coated with the chemical resistant polymer on an inner surface of the steel shell, wherein the outer shell resists impacts to the chemical tote and has sufficient strength to contain any escaped pressurized chemical leaked from the tank.

17. The container of claim 11, wherein the strengthening material comprises one or more of steel, a composite and PTFE.

18. The container of claim 16, wherein the valve assembly comprises:
an entrance valve coupled to a source of a compressed inert gas;
an exit valve coupled to a dispensing system; and
a straw extending into the first shell, wherein the chemical is extracted from the first shell through the straw under pressure of the compressed inert gas.

19. The container of claim 17, wherein the valve is configurable to maintain the chemical under a pressure of at least 400 pounds per square inch.
